(19) United States
(12) Patent Application Publication
(10) Pub. No.: US 2022/0126225 A1
(43) Pub. Date: Apr. 28, 2022

(54) ALL-IN-ONE, PORTABLE, TREATMENT OF DEWATERABLE MATERIAL

(71) Applicant: Charles Jerold Nowling, Highlands, TX (US)

(72) Inventor: Charles Jerold Nowling, Highlands, TX (US)

(21) Appl. No.: 17/081,067

(22) Filed: Oct. 27, 2020

(51) Int. Cl. B01D 33/11; C02F 11/126; C02F 11/13; B01D 33/80; B01D 39/12

(52) U.S. Cl. CPC B01D 33/11; C02F 11/126; C02F 11/13; C02F 2201/008; B01D 39/12; B01D 2201/265; B01D 2201/56; B01D 33/801

(57) ABSTRACT

This disclosure provides apparatuses and methods for a rotatable, cylindrical basket within a housing, wherein the rotatable, cylindrical basket has a longitudinal bore therethrough and an external surface, and, optionally, other surface areas, comprising filtering media. Further, the housing may include an inlet and an outlet, wherein the inlet and the outlet, optionally openable and closeable, and located at least proximate to opposing ends of the rotatable, cylindrical basket. Further still, the apparatus may include a heating unit removably coupled to the rotatable, cylindrical basket, wherein the heating unit is configured to blow hot air onto at least a portion of the filtering media.

### FIELD

This disclosure relates to apparatuses, methods, and systems for separating liquids from solids, usable for filtration and treatment of dewaterable material, such as sludge, pulp, wood chips, grape residue from a winemaking process, and other solid-liquid mixtures.

### BACKGROUND

The term “sludge” may refer to a variety of solid-liquid mixtures, including slurries, emulsions, or any similar mixture, such as sewage, industrial waste, or contaminated mud. A sludge may contain any number of liquid or solid components, and may have any ratio of liquid to solid, though typically, a sludge has somewhat more liquid than solid material. Due to the inherent properties of solid-liquid mixtures, many difficulties exist relating to their handling, treatment, disposal, and analysis.

Environmental regulations require that prior to disposal of a sludge in a landfill, the water content of the sludge be reduced to an acceptable level. Additionally, a solid-liquid mixture containing a significant quantity of liquid is considerably heavier than a mixture from which some or all of the liquid has been removed, causing transport of the mixture to be difficult and cumbersome. Often, freight carriers and other transporters of a sludge, or similar solid-liquid mixture, assess costs based on the weight of the material transported.

To facilitate efficient and less expensive transport and disposal of solid-liquid mixtures, while complying with environmental regulations, various types of liquid-solid separators have been used to remove the liquid components of the mixture from the solid media. Additionally, the separation of solid-liquid mixtures has many noteworthy industrial applications where it is desirable to retain one or more solid or liquid components for treatment, analysis, processing, and/or use.

Generally, filtration through vacuum drainage or gravitational drainage may at least partially separate a solid-liquid mixture. Vacuum drainage requires use of an on-site pump to draw liquid through a filter, and typically necessitates use of a filtrate cavity that remains beneath the surface of the liquid throughout the filtering process. The force of the pump draws solid particles, as well as the liquid portion of the mixture, toward the filter that can cause blockage of the filter, and, thereby, reducing the speed and efficacy of the separation process.

Gravitational drainage involves placing a solid-liquid mixture into a container having one or more filters therein and allowing gravity to pull the liquid through the filters while retaining the solid media. The solid-liquid mixture may be flocculated using one or more suitable polymers prior to filtration, which facilitates the separation of this mixture. If unknown, testing polymer(s) on the waste or other source of the solid-liquid mixture may occur to determine which polymer(s) are best at flocculating this mixture. Since vacuum-pumping is not required for gravitational drainage, it is not necessary to retain the filtrate cavity beneath the liquid level of the sludge. Filters extending throughout the entire height of the container may be used to maximize surface area for the separation process and minimize the potential for blockage of filters.

Gravitational drainage may be extremely slow, and may require multiple days, or weeks, to separate a significant quantity of sludge. Additionally, due to uneven distribution of the sludge within a container, and uneven rates of drainage for differing portions of the sludge, large quantities of liquid may be retained in certain portions of the container for longer periods of time than other portions of the liquid located elsewhere in the container that are separated more rapidly.

To augment separation of solid-liquid mixtures, whether it be sludge or otherwise, e.g., those mixtures mentioned in the first paragraph of this description, it may be desirable to take additional steps beyond drainage. Furthermore, it may be desirable to have a single, mobile apparatus for more easily separating solid-liquid mixtures into what may be class A waste, which assuages financial concerns about dumping waste in landfills. With the foregoing in mind, disclosed are apparatuses, methods, and systems aimed at achieving one or more of these considerations as well as others.

### SUMMARY

In an example embodiment, this disclosure provides an apparatus may include a rotatable, cylindrical basket within a housing, wherein the rotatable, cylindrical basket has a longitudinal bore therethrough and an external surface, and, optionally, other surface areas, comprising filtering media. Further, the housing may include an inlet and an outlet, wherein the inlet and the outlet, optionally openable and closeable, and located at least proximate to opposing ends of the rotatable, cylindrical basket. Further still, the apparatus may include a heating unit removably coupled to the rotatable, cylindrical basket, wherein the heating unit is configured to blow hot air onto at least a portion of the filtering media.

### BRIEF DESCRIPTION OF THE DRAWINGS

So that the manner in which the above recited features, advantages and objects of the present disclosure are attained and can be understood in detail, a more particular description of this disclosure, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for this disclosure may admit to other equally effective embodiments.

FIG. 1 shows an isometric view of a housing having a frame with a rotatable, cylindrical basket therein in addition to the front end having an inlet for optional connection to a non-depicted heating unit, which may or may not be within the same housing as the rotatable, cylindrical basket in accordance with this disclosure.

FIG. 2 shows an isometric view of a housing having a frame, a catwalk, and various surfaces, such as the top, near top, sides and front end, which has an inlet for optional connection to a non-depicted heating unit in accordance with this disclosure.

FIG. 3 shows a rotatable, cylindrical basket having opposing ends as well as filtering media on its internal and external surfaces in accordance with this disclosure.

FIG. 4 shows a cutaway of an apparatus having an interior duct 150 in communication with other ducts for blowing hot air from a non-depicted heating unit directly or indirectly connected to the inlet, which traverses an opposing end, such as the front end in this example but could be the back end having an inlet in another example, wherein the back end is hinged so as to at least partially open and close in accordance with this disclosure.

FIG. 5 shows an isometric, cutaway-in-portions view of the housing having a housing containing a heating unit and electronics that is connected, adjoined, mated or otherwise in close proximity to another housing containing the rotatable, cylindrical basket on optional rotating rod(s), wherein the housings, viewed collectively, are on a trailer having wheels; further, each housing has at least one partial opening, such as the depicted hinged tops, the door on the front end of the heating unit's housing, the door on the back end of the back end of the rotatable, cylindrical basket's housing; further still, the back end of the heating unit's housing and/or the front end of the rotatable, cylindrical basket's housing may or may not have at least a partial wall, optionally openable, closeable and/or removable, therebetween, all of which is in addition or in accordance with this disclosure.

FIG. 6 shows an isometric view of the housing containing a stationary and hinged back end, gear-driven chains, source, sensors, electronics, at least one cylinder (i.e., one or more may be used in various embodiments), a stationary front end, inlet, a lower frame hingeably connected to an upper frame, side and bottom supports for and of the frame, and at least one interior duct in accordance with this disclosure.

FIG. 7 shows a lift on the bottom of the housing in accordance with this disclosure.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

Various specific embodiments, versions and examples are now be described, including exemplary embodiments and definitions that are adopted herein for purposes of understanding. While the following detailed description gives specific embodiments, those skilled in the art will appreciate that these embodiments are exemplary only, and that the disclosure can be practiced in other ways. For purposes of determining infringement, the scope of the invention will refer to the any claims, including their equivalents, and elements or limitations that are equivalent to those that are recited.

Specific structural and functional details disclosed herein are not to be interpreted as limiting, but merely as a basis of the claims and as a representative basis for teaching persons having ordinary skill in the art to variously employ the present invention. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

As used herein, “about” means the number itself and/or within 5% of the stated number. For instance, with about 5%, this means 5 and/or any number or range within the range of 4.75 to 5.25, e.g., 4.75 to 4.96, 4.81 to 5.1, etc.

Throughout this specification, unless the context requires otherwise, the word “comprise” or variations such as “comprises” or “comprising”, will be understood to imply the inclusion of a stated integer or group of integers but not the exclusion of any other integer or group of integers. And other than the claims, the word “comprise” or variations such as “comprises” or “comprising” will be understood to encompass not only the open configuration that the law says “comprise” means, but also understood to include alternative embodiments of “consisting essentially of” and “consisting of” as these two terms are understood in the law to mean.

It is to be appreciated that reference to “one example” or “an example” of the disclosed subject matter is not made in an exclusive sense. Accordingly, one example may exemplify certain aspects of the invention, whilst other aspects are exemplified in a different example. These examples are intended to assist the skilled person in performing what is disclosed and claimed; they are not intended to limit the overall scope of the invention in any way unless the context clearly indicates otherwise.

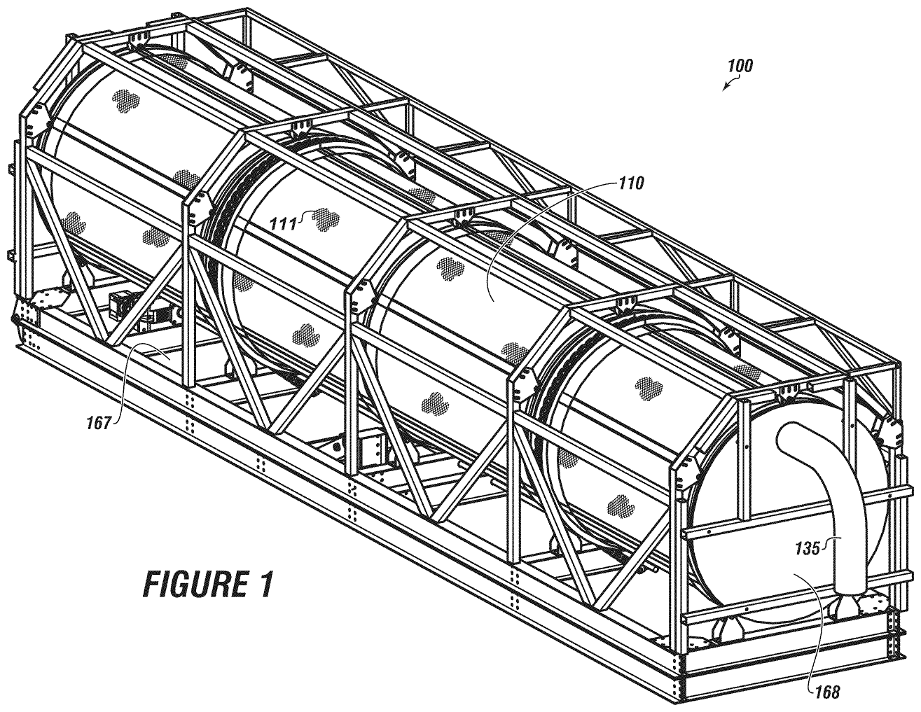

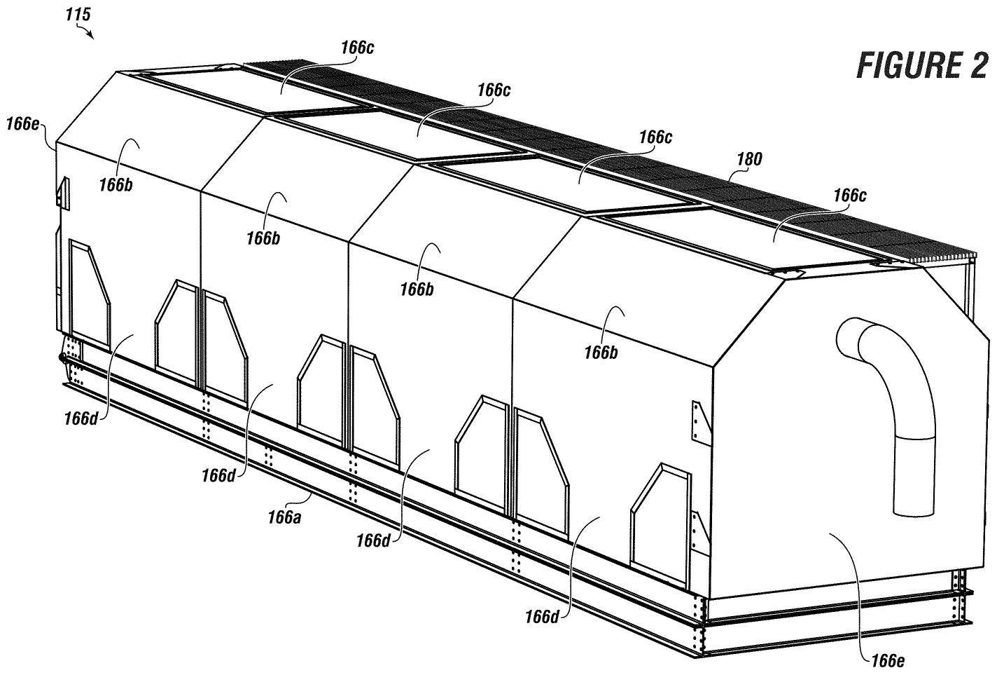

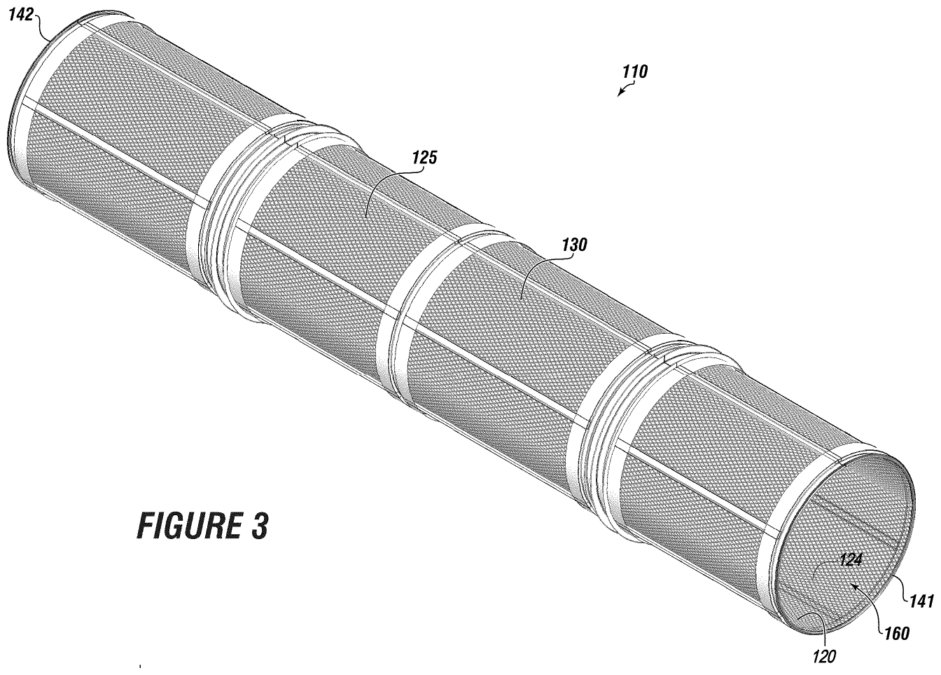

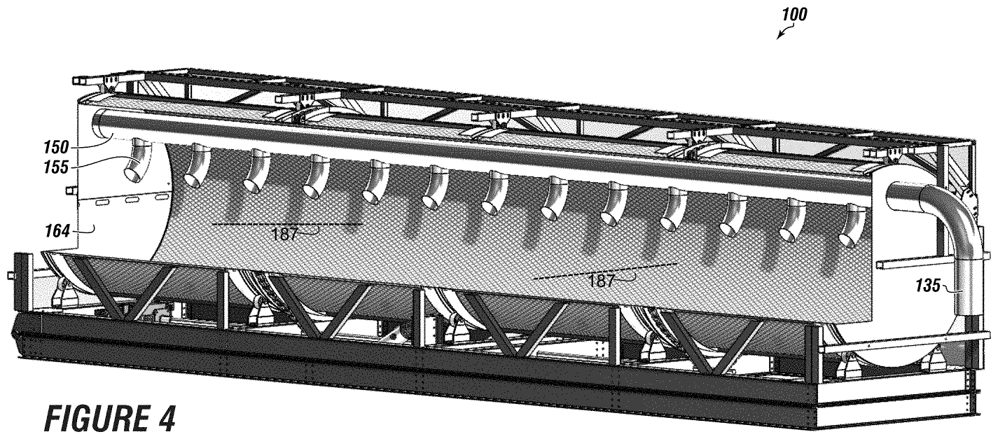

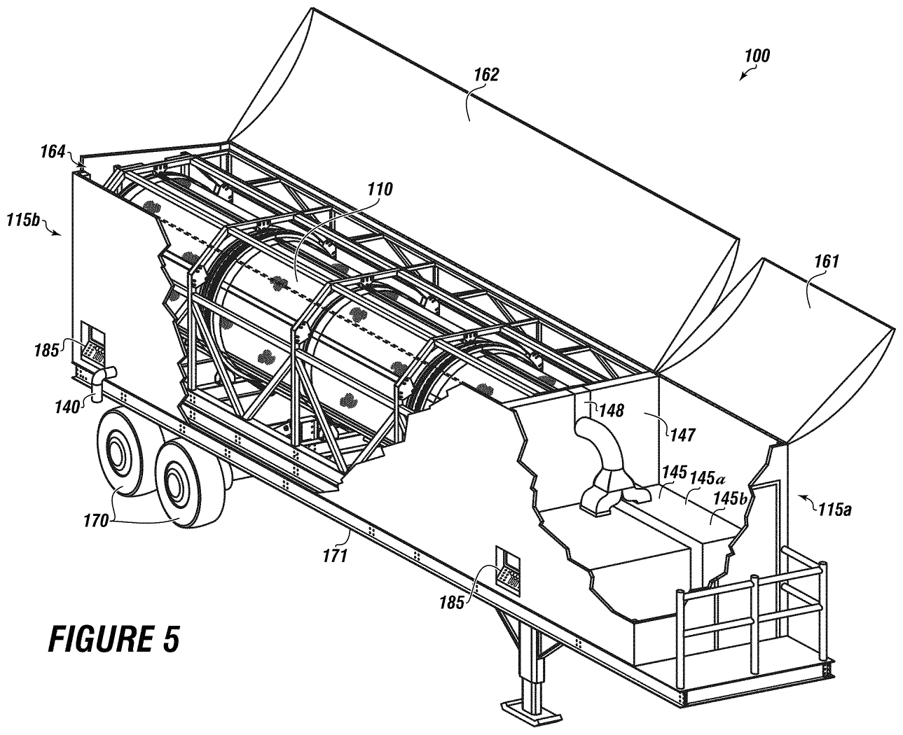

Generally disclosed are apparatuses, methods, and systems for separating liquids from solids, such as those that are usable for filtration and treatment of sludge and other solid-liquid mixtures. Although reference is often made to “sludge.” it is understood that this is in no way limiting, and that the discussion herein relates to any dewaterable material other than just sludge. Turning now to FIGS. 1-7, the figures show an apparatus 100 comprising a rotatable, cylindrical basket 110 within a housing 115, wherein the rotatable, cylindrical basket 110 has a longitudinal bore 120 therethrough 110 and an external surface 125 comprising filtering media 130, which may be located on portion(s) or the entirety of its 110 surface, include the external surface 125. The housing 115 may comprise at least one inlet 135, wherein the at least one inlet 135 is optionally openable and closeable by manual or electronic actuation, is located at least proximate to at least one of the opposing ends 141, 142 of the rotatable, cylindrical basket 110. Further, the apparatus 100 may comprise a heating unit 145, which may be removably coupled to the rotatable, cylindrical basket 110, such as through mating with the at least one inlet 135 with or without additional connectors of any type and size, seals, and so forth as is known in the art. The heating unit 145 may be configured to blow hair air, such as through at least one interior duct 150 one or more other ducts 155 connected thereto 150 and/or in communication therewith 150, onto at least a portion of the filtering media 130, wherein the at least one interior duct 150 and any of the other ducts 155 may be perforated. For example, the at least one interior duct 150 may be integrated or connected to the at least one inlet 135 and runs parallel for at least a portion of a length of the longitudinal bore 120. In additional embodiments, the housing 115 may include one or more dehumidifiers to assist in removing moisture from the apparatus, which, in most circumstances, is a closed system. These one or more dehumidifiers within the housing 115 may be located within and/or outside of the rotatable, cylindrical basket 110. The captured moisture may be drained, whether gravitational or pumped, through an outlet, which optionally has a one-way valve, located at least proximate to a bottom 166a of the housing 115.

Turning to the filtering media 130, the location of the filtering media 130 on one or more surfaces of the external surface 125, internal surface 160 or both 125, 160 may be continuous and/or discontinuous with respect to other location(s). And regarding composition, the filtering media 130 may be made from any natural and/or synthetic material(s), which provide filtering capabilities, e.g., one or more screens having uniform or various porosities and/or structures optionally having embedded additives to enhance filtering. In one example embodiment, filtering media 130 comprises, consists essentially of or consists of stainless steel, which is optionally woven stainless steel. The filtering media 130 may withstand temperatures of at least 800° F., 900° F., 1000° F., or greater than 1000° F.

In some embodiments, there may be one or more sprayers removably couplable to a liquid source so that the one or more sprayers may aim and spray said liquid source, such as water, onto the filtering media 130. Such one or more sprayers, e.g., devices having spray heads and nozzles, may be connected to the inside perimeter of the housing 115, and said liquid source may spray a cleaning solution, with or without the addition of drying additive(s) and/or other additive(s), onto the filtering media 130. The optional additives may physically and/or chemically react with the dewatering material pumped or otherwise brought onto the filtering media 130. Such optional additives may improve drying of the dewatering material, assist in breaking up the dewatering material so as to expose more surface area of the dewatering material, and so forth.

Moving on and in various embodiments, the heating unit 145, which may comprise a dehumidifier and blower, may be separated from the rotatable, cylindrical basket 110 by at least a partial wall 147 therebetween 110, 145, optionally having a removable, wall insert 148 for creating a snug fit around the inlet 135. The heating unit 145 may remove at least some air from the rotatable, cylindrical basket 110 that is cooler than the hot air so as to provide at least a partially, if not completely, closed loop system of blowing in hot air and sucking out cold air before, during or after rotation of the sludge in and on the rotatable, cylindrical basket 110. Regarding configuration, the housing 115 may comprise a housing 115a comprising the heating unit 145 connected with or adjoining to a housing 115b comprising the rotatable, cylindrical basket 110, which, collectively, may be viewed as the housing 115 herein. In other embodiments, there is no separation between the heating unit 145 and the rotatable, cylindrical basket 110 such that both 110, 145 are within the same portion of the housing 115. Additionally and alternatively in various embodiments, the length and size of the rotatable, cylindrical basket 110 and/or the heating unit 145 may vary from apparatus to apparatus. And to that point with respect to the rotatable, cylindrical basket 110, its 110 size and length may be approximately 40 feet long by 7 feet in width and height in one example embodiment, but may vary in length (e.g., any length within 10-50 feet), width, and/or height in other embodiments; however, none of these example dimensions are limiting because the rotatable, cylindrical basket 110 may be any length, width or height that works for the desired dewatering and drying task at hand. Furthermore, the size and length of the rotatable, cylindrical basket 110 may be adjustably set if the rotatable, cylindrical basket 110 is telescopic. That is, the user may desire the rotatable, cylindrical basket 110 to be 15 feet in one operation for use and/or storage, and, thereby, manually or electronically adjust the rotatable, cylindrical basket 110 to telescope within itself 110 to the desired 15 feet configuration. The heating unit 145 may be approximately 2.5 feet long by 6.5 feet in width and height in some embodiments.

The housing 115 may have one or more at least partial openings, such as those at least partial openings 135, 140, 161-164. At least partial openings may appear on any portion(s) of the housing 115, such as the bottom 166a, near top 166b, top 166c, side 166d, end 166e, or portion(s) thereof 166a-e. The at least partial openings, themselves, are doors, windows, ducts, inlets, outlets or combinations thereof, and optionally having seals to improve temperature control, noise reduction, cleanliness, moisture resistance, wear protection, and/or so forth, may allow point(s) of entry and exit between the interior and the exterior of the housing. For instance, in the case where the at least partial openings are inlets and/or outlets, such may traverse the interior 167 to the exterior 168 of the housing 115, and optionally, couple directly or indirectly with the rotatable, cylindrical basket 110, the heating unit 145, other components inside the housing and combinations thereof. The indirect coupling or connecting may occur through use of one or more connectors of any type and size, seals, and so forth as is known in the art.

In various example embodiments, some or none of the at least partial openings do not at least partially open. In embodiments where at least partial opening(s) do occur, the opening may occur through use of hinges, latches, hooks mating with loops, loosening and tightening bolt(s) and/or screw(s), and so forth. For instance, in one embodiment, the housing 115 may have an outlet 140 located at least proximate to an opposing end 142 of the rotatable, cylindrical basket 110, wherein the outlet 140 may be a tube, such as one that may serve as a water port, connected to the opposing end 142 that is in communication, i.e., coupled directly or indirectly, with the interior of the rotatable, cylindrical basket 110. In another example, the opposing end 142 of the rotatable, cylindrical basket 110 has an at least partial opening 164, such as one that allows at least a portion of the opposing end 142 to open and close, wherein the open position is tantamount to the outlet 140 for emptying liquid, waste and/or other purposes. In additional and alternate embodiments, the at least one inlet 135 may double as an outlet 140. One such configuration could arise when the at least one inlet 135 is unconnected or not connected to heating unit 145 so as to render it 135, whether alone or by virtue of mating with duct(s) or other types of tubes, is in communication with the interior of the rotatable, cylindrical basket 110.

Focusing more on the housing 115 at this time, the housing 115 may include one or more wheels 170 at least proximate to the bottom 166a of the housing 115. By “at least proximate” what is meant is that the one or more wheels 170 may be attached to the bottom 166a of the housing 115 or the one or more wheels 170 may be attached to the bottom of a trailer 171 on which the bottom 166a of the housing 115, i.e., including embodiments where there is a 115a and/or 115b, is placed. Regardless of whether attached directly or indirectly, the apparatus may be portable in either configuration so as to provide an all-in-one dewatering, drying and turning apparatus that may turn sludge into class A material, which avoids the need to take the class A material to a landfill, and, thereby, saves money on landfill costs. The housing 115 for the rotatable, cylindrical basket 110 and/or the heating unit 145, whether comprised of housing 115a and housing 115b or collectively 115, may or may not fit on the same trailer 171, such as a flatbed, that complies with U.S. commercial trucking requirements for use on interstates.

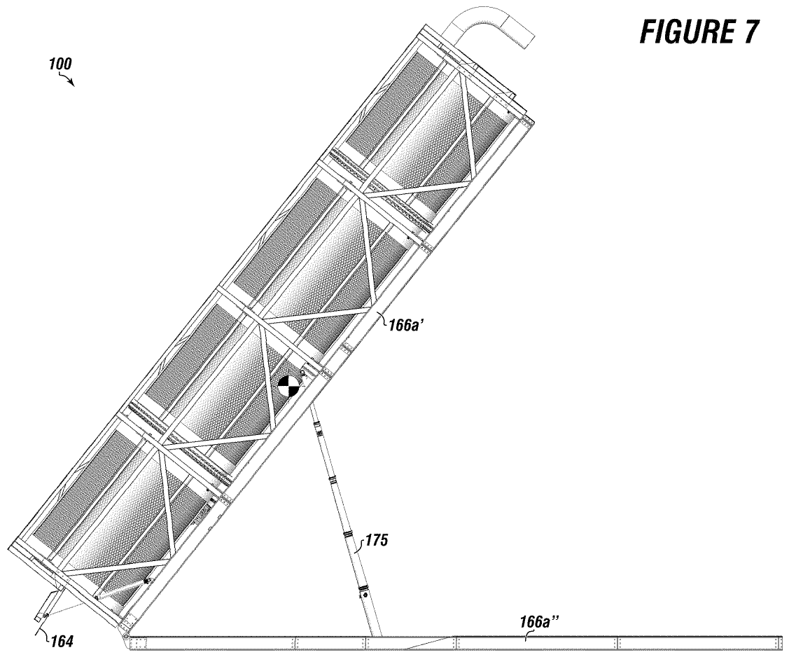

In some embodiments, the housing 115 may include a lift 175 coupled at least proximate to the bottom 166a of the housing 115 or the lift 175 may be attached to the bottom of a trailer 171 on which the bottom 166a of the housing 115, i.e., including embodiments where there is a 115a and/or 115b, is placed. The lift 175, having at least one cylinder, raises and lowers the housing 115 having the rotatable, cylindrical basket 110, which, in a raised state may allow the filtered, liquid waste to exit the rotatable, cylindrical basket 110 through the back door, i.e., one of the two ends 166e, which in various embodiments and like the front end, i.e., the other of the two ends 166e, does or does not turn when the rotatable, cylindrical basket 110 turns, and may be hinged, at least partially removable, or both. Else, in the raised configuration, the filtered, liquid waste may exit the rotatable, cylindrical basket 110 through an outlet, such as outlet 140. As FIG. 7 shows, one example embodiment provides for a lift 175 having a configuration that bifurcates the bottom 166a so that the raised lift 175 is between portions 166a′, 166a″ of the bottom 166a of the housing 115.

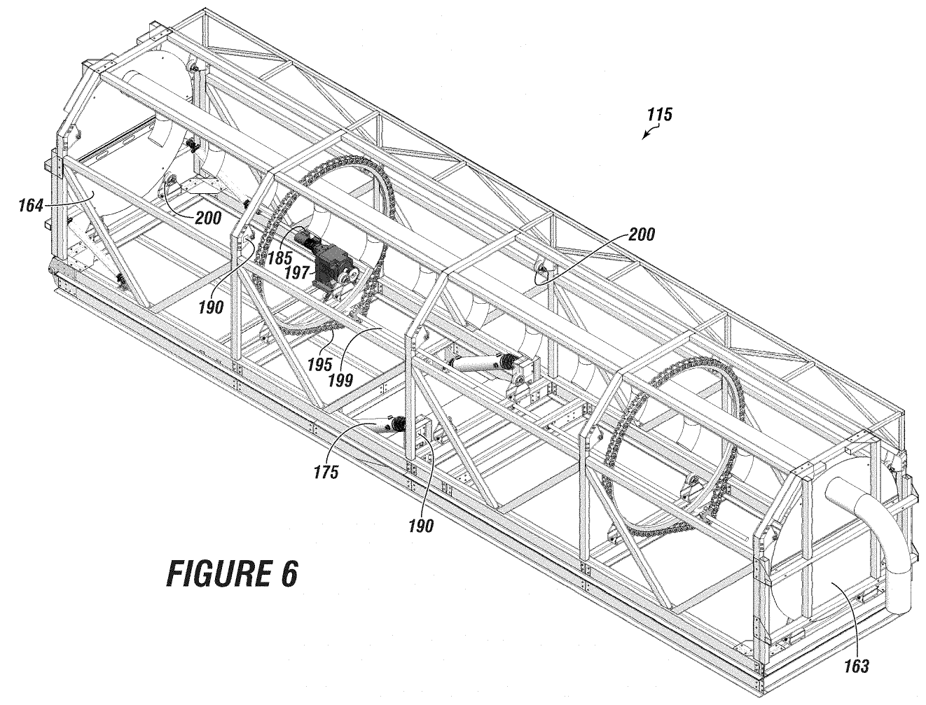

As the figures show, and in particular FIG. 6, the housing 115 may have a frame, which may have constituent parts, including, for example, side and bottom supports as well as a lower frame connected to an upper frame via hinges. In other embodiments, the frame may be connected by other mechanisms than hinges that are known in the art.

The housing 115 may include electronics 185 for reporting data remotely, locally or both. For example, the electronics may report on the dryness of the sludge in the basket 110, whether before, during or after rotation and/or application of hot air from the heating unit 145. The electronics 185 may be distributed over and located anywhere on or in proximity to the housing 115 and be viewable in one or more panels thereon 115. Additionally and alternatively, the housing 115 may include one or more sensors 190, such as, for example, a sensor for measuring hydraulic and/or pneumatic pressure of the at least one cylinder of the lift 175, for sensing temperature, humidity and/or pressure within one or more sections of the apparatus, including compositions within the rotatable, cylindrical basket 110, for sensing properties of components of the apparatus, compositions on or in communication with the components, etc. Similarly, sensors 190 may be distributed over and located anywhere on or in proximity to the housing 115 and be viewable in one or more panels thereon 115.

The housing 115 may further include one or more chain drives 195 located on an exterior of the rotatable, cylindrical basket 110 for coupling to a manual or powered source 197 to rotate the rotatable, cylindrical basket 110. In addition and in the alternative, the housing 115 may include belts that couple to a manual or powered source 197 and to the exterior of the rotate the rotatable, cylindrical basket 110. In various embodiments, the housing may include one or more rotating rods 199 located beneath the rotatable, cylindrical basket 110 and rollers therefor for coupling to a manual or powered source 197 to rotate the rotatable, cylindrical basket 110.

The sludge or other dewaterable material may cease being processed within the housing 115 based on time, weight, dryness, and/or other variable(s). Time may be measured by a clock associated with the start and end of the dewatering process that is located locally or remotely from the apparatus 100. Similarly, weight and dryness may be measured by scale(s) and hygrometers, respectively, or other sensors, that may be located locally or remotely from the apparatus 100. For example, scales may be located beneath the rotatable, cylindrical basket 110, and be able to provide weight before the dewaterable material is on rotatable, cylindrical basket 110 as well as during its processing, wherein reporting of time, weight, dryness, and/or other variable(s) may be through the electronics and/or analog devices associated with the apparatus 100.

In some embodiments and to further facilitate improved drying of the dewaterable material, the rotatable, cylindrical basket 110 may contain a plurality of strings, cords, wires, blades, and/or other items that shred or otherwise cut the dewaterable material so as to increase the surface area of the components within the dewaterable material. In some example embodiments, some or all of the plurality of strings, cords, wires, blades, and/or other items may traverse the inner diameter of the rotatable, cylindrical basket 110. The arrangement of the plurality of strings, cords, wires, blades, and/or other items may be uniformly or non-uniformly distributed within the rotatable, cylindrical basket 110. Furthermore, the arrangement of the plurality of strings, cords, wires, blades, and/or other items may such that one or more is parallel, orthogonal, and/or otherwise with respect to the other(s). In still other additional or alternative embodiments, the interior of the rotatable, cylindrical basket 110 may contain one or more macerators.

The disclosed embodiments provide for beltless, all-in-one, portable apparatuses and methods. By comparison, belt presses often require replacement of expensive belts torn up by components found in dewaterable material as well as multiple persons to operate them. Even after engaging in dewatering steps on the belt presses, the reduced water content of the dewaterable material remains on the belts for removal. The disclosed, all-in-one embodiments provide for reduced water content of the dewaterable material without the use of belts; instead, the dewaterable material is fed onto the filtering media 130 and processed so as to produce a reduced water content of the dewaterable material that may be dumped without the use of manpower during the process. For example, the turn rate of the rotatable, cylindrical basket 110 may be one complete turn per hour, but in other example embodiments, the adjustable turn rate of the rotatable, cylindrical basket 110 may be take more or less time. Furthermore, the dewatered material is dried at least 20% beyond its loss of free water weight in some embodiments, at least 24% beyond its loss of free water weight in other embodiments, and more than at least 24% beyond its loss of free water weight in still other embodiments. And by adding heat to the dewatering process, the dewaterable material may be dried 80%, 85%, 90% or more; that is, 80%, 85%, 90% or more of the moisture content in the dewaterable material may be removed by the dewatering and drying of the dewaterable material on the filtering media 130 on the rotatable, cylindrical basket 110.

Although written in claim format, the following are additional, example embodiments of the disclosed apparatuses and methods:
1. An apparatus comprising:
   a rotatable, cylindrical basket within a housing, wherein the rotatable, cylindrical basket has a longitudinal bore therethrough and an external surface area comprising filtering media;
   the housing having an inlet and an outlet, wherein the inlet and the outlet, optionally openable and closeable, and located at least proximate to opposing ends of the rotatable, cylindrical basket; and
   a heating unit removably coupled to the rotatable, cylindrical basket, wherein the heating unit is configured to blow hair air onto at least a portion of the filtering media.
2. The apparatus of claim 1, wherein the filtering media comprise one or more screens.
3. The apparatus of claim 1, wherein the heating unit removes at least some air from the rotatable, cylindrical basket that is cooler than the hot air.
4. The apparatus of claim 1, wherein the housing has one or more at least partial openings.
5. The apparatus of claim 4, wherein the one or more at least partial openings comprise a side of the housing, a portion of the side of the housing, other inlets and/or outlets traversing from an interior to the exterior of the housing and optionally coupled directly or indirectly with the rotatable, cylindrical basket, the heating unit, other component inside the housing, or combinations thereof.
6. The apparatus of claim 4, wherein the one or more at least partial openings comprise doors, windows, tubes, or combinations thereof.
7. The apparatus of claim 1, wherein the heating unit is within the housing.
8. The apparatus of claim 1, further comprising at least a partial wall between the rotatable, cylindrical basket and the heating unit.
9. The apparatus of claim 1, wherein the housing comprises one or more wheels on a bottom side.
10. The apparatus of claim 1, further comprising a trailer bed having at least a first side and an opposing side, wherein a first side supports the housing and the opposing side optionally comprises one or more wheels.
11. The apparatus of claim 1, further comprising one or more dehumidifiers in the housing.
12. The apparatus of claim 1, further comprising electronics for reporting data remotely, locally or both.
13. The apparatus of claim 1, further comprising one or more sensors for sensing properties of components of the apparatus, compositions on or in communication with the components, or both.
14. The apparatus of claim 1, further comprising a lift coupled to the housing.
15. The apparatus of claim 1, further comprising: (i) one or more macerators; (ii) a plurality of strings, cords, wires, and/or blades; or (iii) both (i) and (ii) within the rotatable, cylindrical basket.
16. The apparatus of claim 1, further comprising one or more chain drives located on an exterior of the rotatable, cylindrical basket for coupling to a manual or powered source to rotate the rotatable, cylindrical basket.
17. The apparatus of claim 1, further comprising one or more rotating rods located beneath the rotatable, cylindrical basket for coupling to a manual or powered source to rotate the rotatable, cylindrical basket.
18. The apparatus of claim 1, wherein the housing has at least one frame.
19. The apparatus of claim 1, further comprising a receptable beneath at least a portion of the rotatable, cylindrical basket.
20. The apparatus of claim 1, further comprising an interior tube integral or connected to the inlet and runs parallel for at least a portion of a length of the longitudinal bore.
21. The apparatus of claim 20, wherein the interior tube is perforated.

While the foregoing is directed to example embodiments of the disclosed invention, other and further embodiments may be devised without departing from the basic scope thereof, wherein the scope of the disclosed apparatuses, systems and methods are determined by one or more claims.

1. An apparatus comprising:
a rotatable, cylindrical basket within a housing, wherein the rotatable, cylindrical basket has a longitudinal bore therethrough, an internal surface area comprising filtering media, and a plurality of strings, cords, wires, or combinations thereof;
the housing having an inlet and an outlet, wherein the inlet and the outlet, optionally openable and closeable, are located at opposing ends of the rotatable, cylindrical basket; and
a heating unit connected with or adjoined to the housing, wherein the heating unit comprises a blower, wherein the heating unit is removably coupled to the rotatable, cylindrical basket, wherein the heating unit is configured to blow hot air onto at least a portion of the filtering media.

2. The apparatus of claim 1, wherein the filtering media comprise one or more screens.

3. The apparatus of claim 1, wherein the heating unit removes at least some air from the rotatable, cylindrical basket that is cooler than the hot air.

4. The apparatus of claim 1, wherein the housing has one or more openings.

5. The apparatus of claim 4, wherein the one or more openings comprise a side of the housing, a portion of the side of the housing, other inlets and/or outlets traversing from an interior to the exterior of the housing and optionally coupled directly or indirectly with the rotatable, cylindrical basket, the heating unit, or combinations thereof.

6. The apparatus of claim 4, wherein the one or more at least partial openings comprise doors, windows, tubes, or combinations thereof.

7. The apparatus of claim 1, wherein the heating unit is within the housing.

8. The apparatus of claim 1, wherein the apparatus is beltless.

9. The apparatus of claim 1, wherein the housing comprises one or more wheels on a bottom side.

10. The apparatus of claim 1, further comprising a trailer bed having at least a first side and an opposing side, wherein a first side supports the housing and the opposing side optionally comprises one or more wheels.

11. The apparatus of claim 1, further comprising one or more dehumidifiers in the housing.

12. The apparatus of claim 1, wherein at least one of the plurality of strings, cords, wires, or combinations thereof traverses an inner diameter of the rotatable, cylindrical basket.

13. The apparatus of claim 1, further comprising one or more sensors for sensing properties of components of the apparatus, compositions on or in communication with the components, or both.

14. The apparatus of claim 1, further comprising a lift coupled to the housing.

15. The apparatus of claim 1, further comprising a plurality of grouped holes in the rotatable, cylindrical basket.

16. The apparatus of claim 15, wherein each of the plurality of grouped holes is arranged randomly on the rotatable, cylindrical basket.

17. The apparatus of claim 15, wherein each of the plurality of grouped holes is arranged in a non-random pattern on the rotatable, cylindrical basket.

18. The apparatus of claim 1, wherein the plurality of strings, cords, wires, or combinations thereof are uniformly distributed within the rotatable, cylindrical basket.

19. (canceled)

20. The apparatus of claim 1, further comprising an interior tube integral or connected to the inlet and runs parallel for at least a portion of a length of the longitudinal bore.

21. The apparatus of claim 20, wherein the interior tube is perforated.

22. An apparatus comprising:
a rotatable, cylindrical basket within a housing, wherein the rotatable, cylindrical basket has a longitudinal bore therethrough, an internal surface area comprising filtering media, and a plurality of grouped holes in the rotatable, cylindrical basket;
the housing having an inlet and an outlet, wherein the inlet and the outlet, optionally openable and closeable, are located at opposing ends of the rotatable, cylindrical basket; and
a heating unit connected with or adjoined to the housing, wherein the heating unit comprises a blower, wherein the heating unit is removably coupled to the rotatable, cylindrical basket, wherein the heating unit is configured to blow hot air onto at least a portion of the filtering media.
